(19) United States
(12) Patent Application Publication
(10) Pub. No.: US 2011/0179926 A1
(43) Pub. Date: Jul. 28, 2011

(54) PROTECTION STRUCTURE FOR CUTTING ELECTRODE STRIP

(75) Inventor: TA-KUANG HUNG, HSINCHU (TW)

(73) Assignee: PHOENIX SILICON INTERNATIONAL CORPORATION, HSINCHU (TW)

(21) Appl. No.: 12/692,005

(22) Filed: Jan. 22, 2010

(51) Int. Cl. B26D 7/27

(52) U.S. Cl. 83/522.11

(57) ABSTRACT

The present invention discloses a protection structure for cutting an electrode strip, which comprises an electrode strip having at least one cutting channel; and two adhesive tapes respectively stuck to the upper and lower surfaces of the cutting channel, and which can effectively prevent from the formation of burrs and the shattering of solidified compounds in cutting the electrode strips, whereby are promoted the quality, stability and reliability of products. Further, the protection structure for cutting an electrode strip of the present invention also functions as an indicator to identify the cutting site.

### BACKGROUND OF THE INVENTION

1. Field of the Invention

The present invention relates to a structure for fabricating a lithium battery, particularly to a protection structure for cutting an electrode strip.

2. Description of the Related Art

With the advance of science and technology, various electronic products persistently evolve to have new functions, such as mobile phones, portable A/V players, digital cameras, and notebook computers. Batteries can dynamically provide power for electronic products. Therefore, batteries are extensively used in electronic products.

Refer to FIG. 1 a diagram schematically showing that a positive electrode strip, a negative electrode strip and separation films are jointly wound into a jelly roll (JR). In fabricating a secondary lithium ion power battery, a long positive electrode strip 2, a long negative electrode strip 4, and two long separation films 6 and 8 are jointly wound into a jelly roll 10. Next, a complicated detective computation works out a cutting site where the jelly roll 10 is cut into a separate battery core having a predetermined size. Then, the battery core is placed in a circular aluminum can, and electrolyte is filled into the aluminum can. However, burrs are likely to appear in cutting electrode strips, and the solidified compounds coated on the surface of the electrode strips are likely to break into shatters. The burrs and shatters may penetrate the separation film and cause short circuit.

Accordingly, the present invention proposes a novel protection structure for cutting an electrode strip to effectively overcome the abovementioned problems.

### SUMMARY OF THE INVENTION

The primary objective of the present invention is to provide a protection structure for cutting an electrode strip, which can prevent from the formation of burrs and the shattering of solidified compounds, whereby are promoted the quality, stability and reliability of products.

Another objective of the present invention is to provide a protection structure for cutting an electrode strip, which can function as an indicator to identify the cutting site in cutting the electrode strip, whereby is reduced the cost of the fabrication equipment.

To achieve the abovementioned objectives, the present invention proposes a protection structure for cutting an electrode strip, which comprises an electrode strip having at least one predetermined cutting channel; and two adhesive tapes respectively stuck to the upper and lower surfaces of the cutting channel.

Below, the embodiments are described in detail in cooperation with drawings to make easily understood the technical contents and efficacies of the present invention.

### BRIEF DESCRIPTION OF THE DRAWINGS

FIG. 1 is a diagram schematically showing that a positive electrode strip, a negative electrode strip and separation films are jointly wound into a jelly roll;

FIG. 2 is a diagram schematically showing a protection structure for cutting an electrode strip according to the present invention;

FIG. 3 is a diagram schematically showing that a cutting knife performs cutting of an electrode strip at a protection structure for cutting an electrode strip according to the present invention; and

FIG. 4 is a diagram schematically showing an electrode strip having been cut by a cutting knife at a protection structure for cutting an electrode strip according to the present invention.

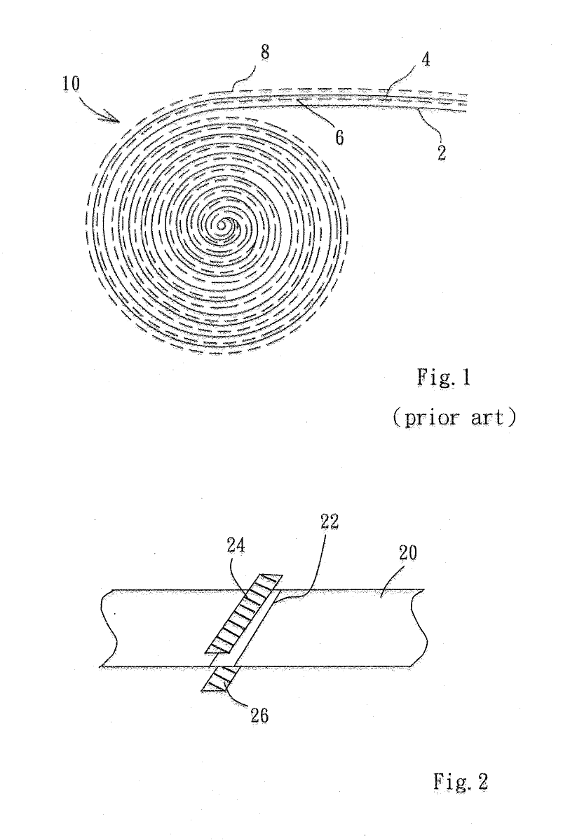

### DETAILED DESCRIPTION OF THE INVENTION

Refer to FIG. 2 a diagram schematically showing a protection structure for cutting an electrode strip according to the present invention. The protection structure for cutting an electrode strip comprises an electrode strip 20 having at least one predetermined cutting channel 22, wherein the electrode strip 20 is a positive electrode strip or a negative electrode strip; and two adhesive tapes 24 and 26 respectively stuck to the upper and lower surfaces of the cutting channel 22.

The adhesive tape 24 or 26 is a Mylar tape having a width of 10-20 mm. The substrate of the adhesive tape 24 or 26 is a polyester film having a thickness of 25 μm. The bottom glue of the adhesive tape 24 or 26 is made of an acrylic material.

The electrode strip 20 is usually a rigid conductive metal strip. The adhesive tapes 24 and 26 are stuck onto the upper and lower surfaces of the cutting channel 22, and contribute the characteristic of a flexible material to prevent from the formation of metal burrs and the shattering of the solidified compounds when the rigid electrode strip 20 is cut. Thereby are promoted the quality, stability and reliability of products.

The solidified compound is referred to the layer coated on the electrode strip 20 except the conductive substrate of the electrode strip 20 (such as a copper foil or an aluminum foil). The solidified compound of the positive electrode strip is lithium iron phosphate, and the solidified compound of the negative electrode strip is a carbon material.

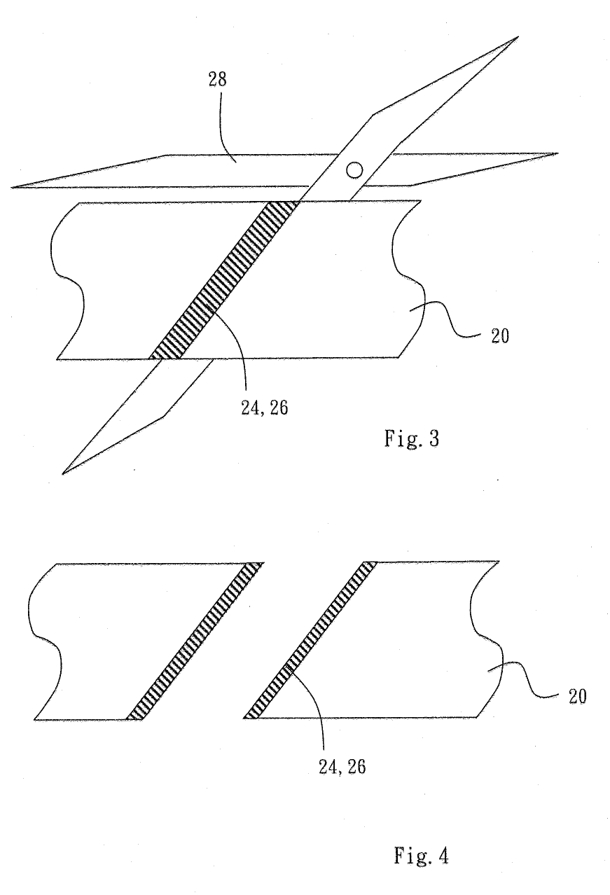

The protection structure for cutting an electrode strip may also function as an indicator to identify the cutting site. When a long positive electrode strip, a long negative electrode strip, and two long separation films are jointly wound into a jelly roll, a photosensor is used to identify the position of the adhesive tapes 24 and 26 according to the color difference. Then, a cutting element 28, such as a cutting knife, performs the cutting of the electrode strips, as shown in FIG. 3. After cutting, the adhesive tapes 24 and 26 are still glued to the cutting edges of the electrode strip 20, as shown in FIG. 4. Thus, neither burrs form nor solidified compounds shatter. Further, the present invention is exempt from the complicated detective computation that the conventional technology uses. Therefore, the present invention can reduce the cost of the fabrication equipment.

In conclusion, the present invention proposes a protection structure for cutting an electrode strip, wherein two adhesive tapes respectively adhere to the upper and lower surfaces of the cutting channel, and effectively prevent from the formation of burrs and the shattering of solidified compounds in cutting the electrode strips, whereby are promoted the quality, stability and reliability of products. Further, the protection structure for cutting an electrode strip of the present invention also functions as an indicator to identify the cutting site.

The embodiments described above are only to exemplify the present invention but not to limit the scope of the present invention. Any equivalent modification or variation according to the spirit of the present invention is to be also included within the scope of the present invention.

What is claimed is:

1. A protection structure for cutting an electrode strip, comprising
an electrode strip having at least one predetermined cutting channel; and
two adhesive tapes respectively stuck to upper and lower surfaces of said cutting channel.

2. The protection structure for cutting an electrode strip according to claim 1, wherein said electrode strip is a positive electrode strip or a negative electrode strip.

3. The protection structure for cutting an electrode strip according to claim 1, wherein said adhesive tape is a Mylar tape.

4. The protection structure for cutting an electrode strip according to claim 3, wherein said adhesive tape has a substrate made of a polyester film and a bottom glue made of an acrylic material.

5. The protection structure for cutting an electrode strip according to claim 4, wherein said substrate has a thickness of 25 μm.

6. The protection structure for cutting an electrode strip according to claim 1, wherein said adhesive tape has a width of 10-20 mm.

7. The protection structure for cutting an electrode strip according to claim 1, wherein said adhesive tape function as an indicator to identify a cutting site in cutting said electrode strip.

8. The protection structure for cutting an electrode strip according to claim 1, wherein a cutting knife performs cutting of said cutting channel where said adhesive tapes are stuck.

9. The protection structure for cutting an electrode strip according to claim 1, which applies to a secondary lithium ion power battery.
